(19) United States
(12) Patent Application Publication
(10) Pub. No.: US 2011/0187309 A1
(43) Pub. Date: Aug. 4, 2011

(54) APPARATUS FOR AUTOMATICALLY SWITCHING AND CHARGING MULTIPLE BATTERIES

(75) Inventors: Kak Man Chan, Hong Kong (HK); Boa Fung Chau, Hong Kong (HK)

(73) Assignee: Acoustic Arc International Ltd.

(21) Appl. No.: 12/698,137

(22) Filed: Feb. 1, 2010

(51) Int. Cl. H01M 10/46; H02J 7/06

(52) U.S. Cl. 320/101; 320/163

(57) ABSTRACT

An apparatus for automatically switching and charging a first battery and a second battery includes a charger unit; an output port configured for connecting to a load; a first control switch connected between the charger unit and the first battery; a second control switch connected between the charger unit and the second battery; a first output switch connected between the first battery and the output port; a second output switch connected between the second battery and the output port; a main control unit connected with the first and second batteries, the first and second control switches, and the first and second output switch modules; and a power source module configured for providing power to the main control unit and the charger unit. The main control unit is configured to monitor the output voltages of the first and the second batteries, and if the output voltage of the first battery is lower than that of the second battery to turn on the first control switch and the second output switch and turn off the first output switch and the second control switch so that the first battery is being charged by the charger unit and the second battery is providing power to the load connected to the output port.

### FIELD OF THE PATENT APPLICATION

The present invention generally relates to power source technologies and more particularly to an apparatus for automatically switching and charging multiple batteries.

### BACKGROUND

Batteries have become an indispensible component of many electronic devices that people use today. When a battery is depleted, to ensure proper working of the electronic device using the battery, the battery must be replaced by a fully charged battery. If the depleted battery is a rechargeable battery, the depleted battery may be recharged while not being used by the electronic device. After the originally depleted battery is fully recharged, it is ready to be used to replace another depleted battery in the electronic device.

Conventionally the aforementioned operations of switching and recharging batteries in an electronic device are manual, and may take some time and cause inconveniences.

### SUMMARY

The present patent application is directed to an apparatus for automatically switching and charging a first battery and a second battery. The apparatus includes a charger unit; an output port configured for connecting to a load; a first control switch connected between the charger unit and the first battery; a second control switch connected between the charger unit and the second battery; a first output switch connected between the first battery and the output port; a second output switch connected between the second battery and the output port; a main control unit connected with the first and second batteries, the first and second control switches, and the first and second output switch modules; and a power source module configured for providing power to the main control unit and the charger unit. The main control unit is configured to monitor the output voltages of the first and the second batteries, and if the output voltage of the first battery is lower than that of the second battery to turn on the first control switch and the second output switch and turn off the first output switch and the second control switch so that the first battery is being charged by the charger unit and the second battery is providing power to the load connected to the output port.

The main control unit may be further configured to turn off the first control switch and the second output switch and turn on the first output switch and the second control switch so that the second battery is being charged by the charger unit and the first battery is providing power to the load connected to the output port when the output voltage of the second battery is below a predetermined threshold voltage after the second battery powers the load for a period of time.

The apparatus may further include a first battery reference voltage unit connected between the first battery and the main control unit and configured to provide a proportioned sample of the output voltage of the first battery to the main control unit; and a second battery reference voltage unit connected between the second battery and the main control unit and configured to provide a proportioned sample of the output voltage of the second battery to the main control unit.

The apparatus may further include a regulator unit connected between the power source module and the main controller and configured for providing a regulated voltage to power the main control unit.

The apparatus may further include two light-emitting diodes respectively connected between the main control unit and the charger unit, and configured for indicating the charging and usage status of the first and the second batteries.

The power source module may include a solar panel and a Universal Serial Bus interface providing a DC voltage connected in parallel, and the main control unit may be a microcontroller unit.

In another aspect, the present patent application provides an apparatus for automatically switching and charging a first battery and a second battery. The apparatus includes a charger unit; an output port configured for connecting to a load; a first control switch connected between the charger unit and the first battery; a second control switch connected between the charger unit and the second battery; a first output switch connected between the first battery and the output port; a second output switch connected between the second battery and the output port; a main control unit connected with the first and second batteries, the first and second control switches, and the first and second output switch modules; and a power source module configured for providing power to the main control unit and the charger unit. The main control unit is configured to monitor the output voltages of the first and the second batteries; if the output voltage of the first battery is lower than that of the second battery to turn on the first control switch and the second output switch and turn off the first output switch and the second control switch so that the first battery is being charged by the charger unit and the second battery is providing power to the load connected to the output port; and when the output voltage of the second battery is below a predetermined threshold voltage after the second battery powers the load for a period of time to turn off the first control switch and the second output switch and turn on the first output switch and the second control switch so that the second battery is being charged by the charger unit and the first battery is providing power to the load connected to the output port.

In yet another aspect, the present patent application provides a system for automatically switching and charging multiple batteries. The system includes a first battery; a second battery; a charger unit; an output port configured for connecting to a load; a first control switch connected between the charger unit and the first battery; a second control switch connected between the charger unit and the second battery; a first output switch connected between the first battery and the output port; a second output switch connected between the second battery and the output port; a main control unit connected with the first and second batteries, the first and second control switches, and the first and second output switch modules; and a power source module configured for providing power to the main control unit and the charger unit. The main control unit is configured to monitor the output voltages of the first and the second batteries, and if the output voltage of the first battery is lower than that of the second battery to turn on the first control switch and the second output switch and turn off the first output switch and the second control switch so that the first battery is being charged by the charger unit and the second battery is providing power to the load connected to the output port.

### BRIEF DESCRIPTION OF THE DRAWINGS

FIG. 1 is a block diagram of an apparatus for automatically switching and charging multiple batteries according to an embodiment of the present patent application.

FIG. 2 is a schematic circuit diagram of the apparatus for automatically switching and charging multiple batteries depicted in FIG. 1.

### DETAILED DESCRIPTION

Reference will now be made in detail to a preferred embodiment of the apparatus for automatically switching and charging multiple batteries disclosed in the present patent application, examples of which are also provided in the following description. Exemplary embodiments of the apparatus for automatically switching and charging multiple batteries disclosed in the present patent application are described in detail, although it will be apparent to those skilled in the relevant art that some features that are not particularly important to an understanding of the apparatus for automatically switching and charging multiple batteries may not be shown for the sake of clarity.

Furthermore, it should be understood that the apparatus for automatically switching and charging multiple batteries disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

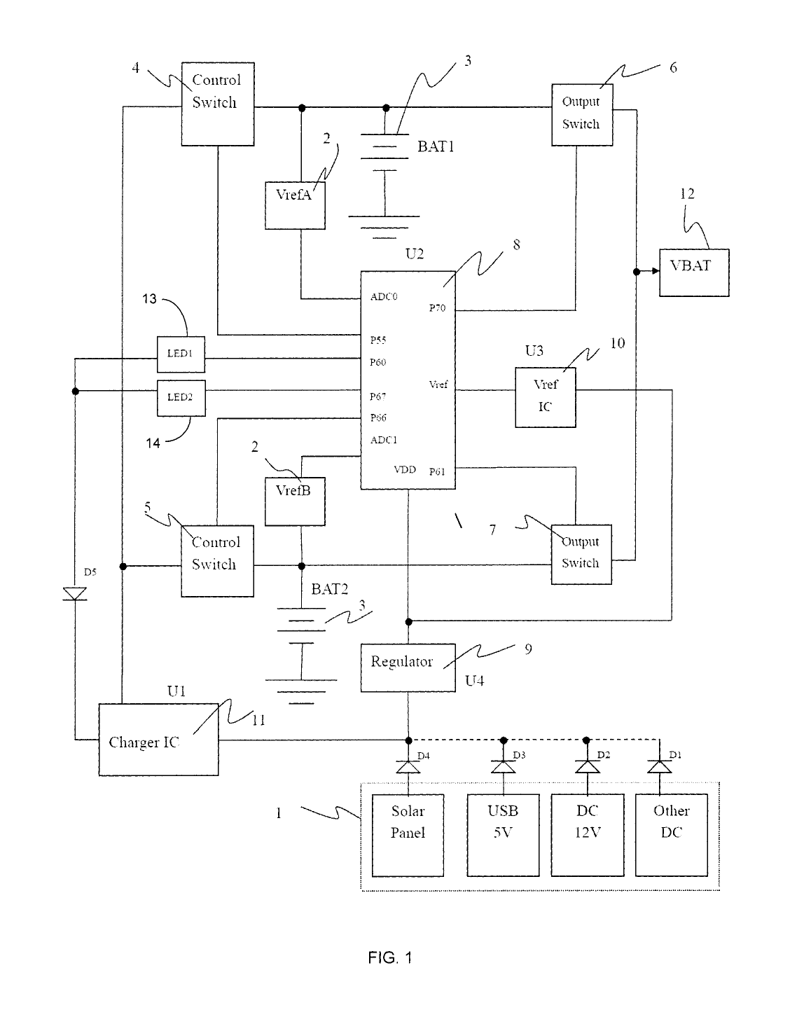

FIG. 1 is a block diagram of an apparatus for automatically switching and charging multiple batteries according to an embodiment of the present patent application. Referring to FIG. 1, in this embodiment, the apparatus is configure for automatically switching and charging two batteries 3, which includes a battery BAT1 and another battery BAT2. The apparatus includes a power source module 1, a battery reference voltage module 2, two control switch modules 4 and 5, two output switch modules 6 and 7, a main control unit 8, a regulator unit 9, a reference voltage unit 10, a charger unit 11, and an output port 12. The battery reference voltage module 2 includes a first battery reference voltage unit VrefA and a second battery reference voltage unit VrefB. The main control unit 8 is connected with the power source module 1 through the regulator unit 9, with the first battery BAT1 through the first battery reference voltage unit VrefA, with the second battery BAT2 through the second battery reference voltage unit VrefB, with the control switch modules 4 and 5, with the output switch modules 6 and 7, and with the reference voltage unit 10. The charger unit 11 is connected with the power source module 1. The charger unit 11 is also connected with the first and second battery BAT1 and BAT2 through the control switch modules 4 and 5 respectively. The batteries BAT1 and BAT2 are connected with the output port 12 respectively through the output switch modules 6 and 7.

The power source module 1 may include a variety of power sources. Referring to FIG. 1, in this embodiment, the power source module 1 includes a solar panel, a USB (Universal Serial Bus) interface providing 5V DC voltage, a 12 V DC power source and other DC power sources. In this embodiment, each power source is connected in series with a diode and in parallel with each other.

The charger unit 11 includes a standalone linear battery charger with a complete pre-charge, constant-current and constant-voltage charge loop. The output voltage of the charger unit 11 is regulated at 4.2V. The output current of the charger unit 11 is programmable. In this embodiment, the batteries BAT1 and BAT2 are Lithium batteries. It is understood that the charger unit 11 may be an integrated circuit.

The control switch module 4 is connected between the charger unit 11 and the battery BAT1. The control switch module 5 is connected between the charger unit 11 and the battery BAT2. The control switch modules 4 and 5 may be semiconductor switches and controlled by the main control unit 8 to determine which one of the batteries BAT1 and BAT2 is being charged by the charger unit 11. More specifically, when the control switch module 4 is turned on, the charger unit 11 is charging the battery BAT1; when the control switch module 5 is turned on, the charger unit 11 is charging the battery BAT2.

The output switch module 6 is connected between the battery BAT1 and the output port 12. The output switch module 7 is connected between the battery BAT2 and the output port 12. The output switch modules 6 and 7 may be semiconductor switches and controlled by the main control unit 8 to determine which one of the batteries BAT1 and BAT2 is supplying a power to the output port 12. More specifically, when the output switch module 6 is turned on, the output voltage of the battery BAT1 is provided to the output port 12; when the output switch module 7 is turned on, the output voltage of the battery BAT2 is provided to the output port 12.

The main control unit 8 is a microcontroller unit (MCU) powered by the power source module 1 through the regulator unit 9. The regulator unit 9 includes a low dropout and low noise regulator providing a working voltage for the main control unit 8. In this embodiment, the output voltage of the regulator unit 9 is 3.3V. The main controller 8 is configured to compare the output voltages of the two batteries BAT1 and BAT2, to control the control switch modules 4 and 5 to enable the charger unit 11 to charge the battery with a lower output voltage, and to control the output switch modules 6 and 7 to provide the output voltage of the battery with a higher output voltage to the output port 12. After some time of use, when the output voltage of the battery that is providing power to the output port 12 (for example the battery BAT2) drops to be below a predetermined threshold voltage VT, the main controller 8 is further configured to control the control switch modules 4 and 5 to stop charging the battery being charged (BAT1 in this example) and start to charge the battery being used to providing power to the output port 12 (BAT2 in this example), and to control the output switch modules 6 and 7 to stop providing the power of the battery being used to providing power (BAT2 in this example) to the output port 12 and start to provide the power of the other battery (BAT1 in this example) to the output port 12.

The first battery reference voltage unit VrefA is configured to provide a proportioned sample of the output voltage of the battery BAT1 to the main control unit 8. The second battery reference voltage unit VrefB is configured to provide a proportioned sample of the output voltage of the battery BAT2 to the main control unit 8. By comparing the two proportioned samples of the output voltages of the two batteries, the main control unit 8 can thus make a comparison between the output voltages of the two batteries. The reference voltage unit 10 is a high-precision, low power DC regulator driven by the regulator unit 9 and configured to generate a 2.0V DC reference voltage for the main control unit 8 to process and assess the proportioned samples of voltages.

In this embodiment, the apparatus for automatically switching and charging multiple batteries further include two LEDs (light-emitting diodes) 13 and 14, which are respectively connected between the main control unit 8 and the charger unit 11. When the main control unit 8 controls the battery BAT1 to be charged by the charger unit 11 and the battery BAT2 to be providing power to the output port 12, the main control unit 8 is configured to turn the LED 13 to be blinking and turn the LED 14 to be steady-on; when the main control unit 8 controls the battery BAT2 to be charged by the charger unit 11 and the battery BAT1 to be providing power to the output port 12, the main control unit 8 is configured to turn the LED 14 to be blinking and turn the LED 13 to be steady-on. With the indication from the LEDs 13 and 14, a user is able to tell which battery is being charged and which battery is being used to provide power.

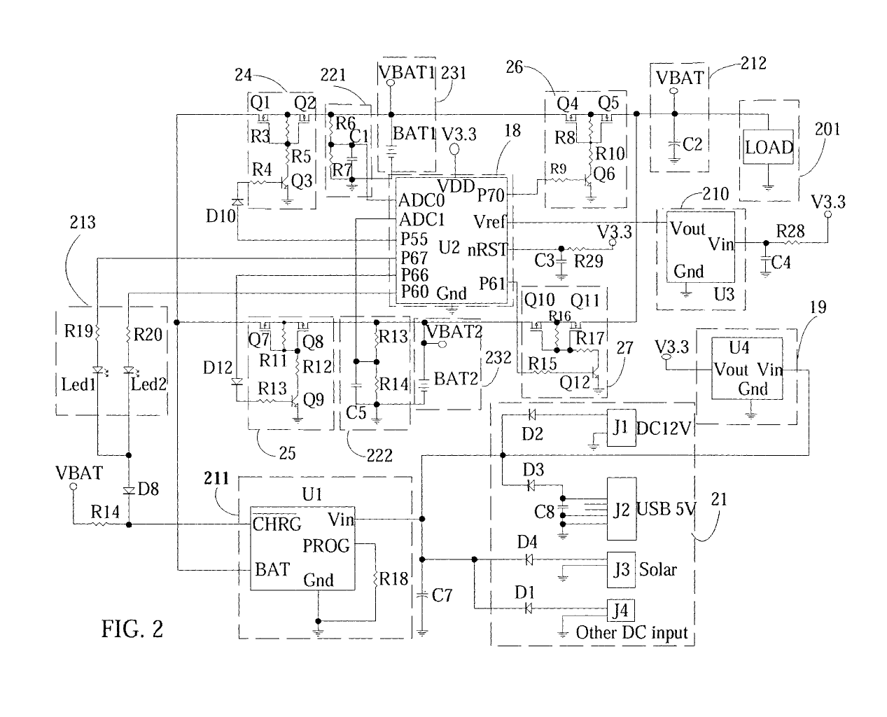

FIG. 2 is a schematic circuit diagram of the apparatus for automatically switching and charging multiple batteries depicted in FIG. 1. Referring to FIG. 2 and FIG. 1, the block 21 in FIG. 2 corresponds to the power source module 1 in FIG. 1. The block 211 in FIG. 2 corresponds to the charger unit 11 in FIG. 1. The blocks 231 and 232 in FIG. 2 respectively correspond to the batteries BAT1 and BAT2 in FIG. 1. The blocks 24 and 25 in FIG. 2 respectively correspond to the control switch modules 4 and 5 in FIG. 1. The blocks 26 and 27 in FIG. 2 respectively correspond to the output switch modules 6 and 7 in FIG. 1. The port 212 in FIG. 2 corresponds to the output port 12 in FIG. 1 and is configured for being connected to a load 201. The block 18 in FIG. 2 corresponds to the main control unit 8 in FIG. 1, which includes a microcontroller unit (MCU). The block 19 in FIG. 2 corresponds to the regulator unit 9 in FIG. 1. The blocks 221 and 222 in FIG. 2 respectively correspond to the first and the second battery reference voltage unit VrefA and VrefB in FIG. 1. The block 210 in FIG. 2 corresponds to the reference voltage unit 10 in FIG. 1. The block 213 in FIG. 2 corresponds to the LEDs 13 and 14 in FIG. 1.

Referring to FIG. 2, the input voltage V_{ADC0} at the port ADC0 of the MCU 18 is V_{BAT1}R₇/(R₆+R₇) and the input voltage V_{ADC1} at the port ADC1 of the microcontroller 18 is V_{BAT2}R₁₄/(R₁₃+R₁₄), where V_{BAT1} and V_{BAT2} are the output voltages of the batteries BAT1 and BAT2 respectively. The microcontroller unit 18 compares the value of V_{ADC0} and V_{ADC1} and controls the blocks 24, 25, 26 and 27 accordingly.

For example, if V_{ADC0} is less than V_{ADC1}, which means the battery BAT1 is more charged than the battery BAT2, the pin 12 of the MCU 18 outputs a high level voltage through the diode D10 to the base of the transistor Q3 so that the transistors Q1 and Q2 are turned on and the battery BAT1 is being charged by the charger unit 211. The pin 8 of the MCU 18 outputs a low level voltage through the diode D12 to the base of the transistor Q9 so that the transistors Q7 and Q8 are turned off and the battery BAT2 is not being charged by the charger unit 211. The pin 11 of the MCU 18 outputs a low level voltage to the base of the transistor Q6 so that the transistors Q4 and Q5 are turned off and the output voltage of the battery BAT1 is not provided to the output port 212 for the load 201 to use. The pin 7 of the MCU 18 outputs a high level voltage to the base of the transistor Q12 so that the transistors Q10 and Q11 are turned on and the output voltage of the battery BAT2 is being provided to the output port 212 for the load 201 to use.

It is understood that if V_{ADC0} is greater than V_{ADC1}, by the similar mechanism as aforementioned, the battery BAT1 will be providing power to the load 201 through the port 212 and the battery BAT2 will be charged by the charger unit 211.

In this example, after the battery BAT2 has been used to power the load 201 for some time, the output voltage of the battery BAT2 drops to be below a predetermined threshold voltage. At this point, the pin 12 of the MCU 18 outputs a low level voltage through the diode D10 to the base of the transistor Q3 so that the transistors Q1 and Q2 are turned off and the battery BAT1 is not being charged by the charger unit 211. In the embodiment, the predetermined threshold voltage is set to be approximately 3.3V. The pin 8 of the MCU 18 outputs a high level voltage through the diode D12 to the base of the transistor Q9 so that the transistors Q7 and Q8 are turned on and the battery BAT2 is being charged by the charger unit 211. The pin 11 of the MCU 18 outputs a high level voltage to the base of the transistor Q6 so that the transistors Q4 and Q5 are turned on and the output voltage of the battery BAT1 is provided to the output port 212 for the load 201 to use. The pin 7 of the MCU 18 outputs a low level voltage to the base of the transistor Q12 so that the transistors Q10 and Q11 are turned off and the output voltage of the battery BAT2 is not being provided to the output port 212 for the load 201 to use.

It is understood that after the battery BAT1 has been used to power the load 201 for some time, the output voltage of the battery BAT1 drops to be below the predetermined threshold voltage (3.3V in this embodiment), by the similar mechanism as aforementioned, the battery BAT2 will be providing power to the load 201 through the port 212 and the battery BAT1 will be charged by the charger unit 211.

In the above embodiment, there are only two batteries for the apparatus to operate on. It is understood that the number of the batteries may be more than two, in which case, more ports of the MCU 18 may be utilized and multiple MCUs may be used to provide proper control of charging and using the multiple batteries.

While the present patent application has been shown and described with particular references to a number of embodiments thereof, it should be noted that various other changes or modifications may be made without departing from the scope of the present invention.

What is claimed is:

1. An apparatus for automatically switching and charging a first battery and a second battery, the apparatus comprising:
a charger unit;
an output port configured for connecting to a load;
a first control switch connected between the charger unit and the first battery;
a second control switch connected between the charger unit and the second battery;
a first output switch connected between the first battery and the output port;
a second output switch connected between the second battery and the output port;
a main control unit connected with the first and second batteries, the first and second control switches, and the first and second output switch modules; and
a power source module configured for providing power to the main control unit and the charger unit; wherein:
the main control unit is configured to monitor the output voltages of the first and the second batteries, and if the output voltage of the first battery is lower than that of the second battery to turn on the first control switch and the second output switch and turn off the first output switch and the second control switch so that the first battery is being charged by the charger unit and the second battery is providing power to the load connected to the output port.

2. The apparatus of claim 1, wherein the main control unit is further configured to turn off the first control switch and the second output switch and turn on the first output switch and the second control switch so that the second battery is being charged by the charger unit and the first battery is providing power to the load connected to the output port when the output voltage of the second battery is below a predetermined threshold voltage after the second battery powers the load for a period of time.

3. The apparatus of claim 1 further comprising: a first battery reference voltage unit connected between the first battery and the main control unit and configured to provide a proportioned sample of the output voltage of the first battery to the main control unit; and a second battery reference voltage unit connected between the second battery and the main control unit and configured to provide a proportioned sample of the output voltage of the second battery to the main control unit.

4. The apparatus of claim 1 further comprising a regulator unit connected between the power source module and the main controller and configured for providing a regulated voltage to power the main control unit.

5. The apparatus of claim 4 further comprising a reference voltage unit connected between the regulator unit and the main control unit and configured to generate a reference voltage for the main control unit to monitor the output voltages of the first and the second batteries.

6. The apparatus of claim 1 further comprising two light-emitting diodes respectively connected between the main control unit and the charger unit, and configured for indicating the charging and usage status of the first and the second batteries.

7. The apparatus of claim 1, wherein the power source module comprises a solar panel and a Universal Serial Bus interface providing a DC voltage connected in parallel, and the main control unit is a microcontroller unit.

8. An apparatus for automatically switching and charging a first battery and a second battery, the apparatus comprising:
a charger unit;
an output port configured for connecting to a load;
a first control switch connected between the charger unit and the first battery;
a second control switch connected between the charger unit and the second battery;
a first output switch connected between the first battery and the output port;
a second output switch connected between the second battery and the output port;
a main control unit connected with the first and second batteries, the first and second control switches, and the first and second output switch modules; and
a power source module configured for providing power to the main control unit and the charger unit; wherein:
the main control unit is configured to monitor the output voltages of the first and the second batteries; if the output voltage of the first battery is lower than that of the second battery to turn on the first control switch and the second output switch and turn off the first output switch and the second control switch so that the first battery is being charged by the charger unit and the second battery is providing power to the load connected to the output port; and when the output voltage of the second battery is below a predetermined threshold voltage after the second battery powers the load for a period of time to turn off the first control switch and the second output switch and turn on the first output switch and the second control switch so that the second battery is being charged by the charger unit and the first battery is providing power to the load connected to the output port.

9. The apparatus of claim 8 further comprising: a first battery reference voltage unit connected between the first battery and the main control unit and configured to provide a proportioned sample of the output voltage of the first battery to the main control unit; and a second battery reference voltage unit connected between the second battery and the main control unit and configured to provide a proportioned sample of the output voltage of the second battery to the main control unit.

10. The apparatus of claim 8 further comprising a regulator unit connected between the power source module and the main controller and configured for providing a regulated voltage to power the main control unit.

11. The apparatus of claim 10 further comprising a reference voltage unit connected between the regulator unit and the main control unit and configured to generate a reference voltage for the main control unit to monitor the output voltages of the first and the second batteries.

12. The apparatus of claim 8 further comprising two light-emitting diodes respectively connected between the main control unit and the charger unit, and configured for indicating the charging and usage status of the first and the second batteries.

13. The apparatus of claim 8, wherein the power source module comprises a solar panel and a Universal Serial Bus interface providing a DC voltage connected in parallel, and the main control unit is a microcontroller unit.

14. A system for automatically switching and charging multiple batteries, the system comprising:
a first battery;
a second battery;
a charger unit;
an output port configured for connecting to a load;
a first control switch connected between the charger unit and the first battery;
a second control switch connected between the charger unit and the second battery;
a first output switch connected between the first battery and the output port;
a second output switch connected between the second battery and the output port;
a main control unit connected with the first and second batteries, the first and second control switches, and the first and second output switch modules; and
a power source module configured for providing power to the main control unit and the charger unit; wherein:
the main control unit is configured to monitor the output voltages of the first and the second batteries, and if the output voltage of the first battery is lower than that of the second battery to turn on the first control switch and the second output switch and turn off the first output switch and the second control switch so that the first battery is being charged by the charger unit and the second battery is providing power to the load connected to the output port.

15. The system of claim 14, wherein the main control unit is further configured to turn off the first control switch and the second output switch and turn on the first output switch and the second control switch so that the second battery is being charged by the charger unit and the first battery is providing power to the load connected to the output port when the output voltage of the second battery is below a predetermined threshold voltage after the second battery powers the load for a period of time.

16. The system of claim 14 further comprising: a first battery reference voltage unit connected between the first battery and the main control unit and configured to provide a proportioned sample of the output voltage of the first battery to the main control unit; and a second battery reference voltage unit connected between the second battery and the main control unit and configured to provide a proportioned sample of the output voltage of the second battery to the main control unit.

17. The system of claim 14 further comprising a regulator unit connected between the power source module and the main controller and configured for providing a regulated voltage to power the main control unit.

18. The system of claim 17 further comprising a reference voltage unit connected between the regulator unit and the main control unit and configured to generate a reference voltage for the main control unit to monitor the output voltages of the first and the second batteries.

19. The system of claim 14 further comprising two light-emitting diodes respectively connected between the main control unit and the charger unit, and configured for indicating the charging and usage status of the first and the second batteries.

20. The system of claim 14, wherein the power source module comprises a solar panel and a Universal Serial Bus interface providing a DC voltage connected in parallel, and the main control unit is a microcontroller unit.
